(19) United States
(12) Patent Application Publication
(10) Pub. No.: US 2018/0329095 A1
(43) Pub. Date: Nov. 15, 2018

(54) OPTICAL FIBER ACOUSTIC SENSING CABLE FOR DISTRIBUTED ACOUSTIC SENSING OVER LONG DISTANCES AND IN HARSH ENVIRONMENTS

(71) Applicant: OFS Fitel, LLC, Norcross, GA (US)

(72) Inventor: John E. Pacini, Glastonbury, CT (US)

(73) Assignee: OFS Fitel, LLC, Norcross, GA (US)

(21) Appl. No.: 15/935,240

(22) Filed: Mar. 26, 2018

Related U.S. Application Data
(60) Provisional application No. 62/503,460, filed on May 9, 2017.

(51) Int. Cl. G01V 1/22; G01D 5/26

(52) U.S. Cl. CPC G01V 1/226; G01D 5/264; G01D 5/268

(57) ABSTRACT

Disclosed herein is a cable sensor comprising an optical fiber; where the optical fiber comprises an optical core upon which is disposed a cladding; and a primary coating; a deformable material surrounding the optical fiber; and an outer tube surrounding the deformable material; where the optical fiber is longer than the outer tube by an amount of 0.1 to 2%. Disclosed herein too is a method for producing a cable sensor comprising mounting an optical fiber on a spool; where the optical fiber comprises a core; a cladding and a primary coating; charging the optical fiber from the spool to an extruder; extruding an outer tube onto the optical fiber such that a region between the optical fiber and the outer tube comprises a deformable material; elongating the optical fiber and the outer tube together to a desired amount; and relaxing the optical fiber and the outer tube; where the optical fiber retains a larger portion of the elongation than the outer tube.

### CROSS REFERENCE TO RELATED APPLICATION

This disclosure claims priority to U.S. Provisional Application No. 62/503,460, filed on May 9, 2017, the entire contents of which are hereby incorporated by reference.

### BACKGROUND

This disclosure relates to an optical fiber acoustic sensing cable, methods of manufacturing thereof and to articles comprising the same. More specifically, this disclosure relates to an optical fiber acoustic sensing cable for distributed acoustic sensing over long distances in harsh environments.

Rayleigh scattering based distributed acoustic sensing (DAS) systems use optical fibers to provide phase-sensitive coherent optical time-domain reflectometry. The accuracy and sensitivity of the optical fiber acoustic sensor cable is adversely affected by both temperature and strain. Like acoustic signals, temperature and strain signals also cause Rayleigh scatting of the optical pulse in the sensing system. Temperature and strain signals are often transmitted over very long distances, up to 50 kilometers and over a wide temperature range of −50° C. to +150° C., and in very harsh chemical environments, such as, for example, in oil well monitoring applications. It is therefore desirable for the optical fiber (used as an acoustic sensor) to be provided with a protective environment where the acoustic sensing fiber is isolated from any external strain that may interact with the optical fiber used for transmitting the acoustic signal.

### SUMMARY

Disclosed herein is a cable sensor comprising an optical fiber; where the optical fiber comprises an optical core upon which is disposed a cladding; and a primary coating; a deformable material surrounding the optical fiber; and an outer tube surrounding the deformable material; where the optical fiber is longer than the outer tube by an amount of 0.1 to 2%.

Disclosed herein too is a method for producing a cable sensor comprising mounting an optical fiber on a spool; where the optical fiber comprises a core; a cladding and a primary coating; charging the optical fiber from the spool to an extruder; extruding an outer tube onto the optical fiber such that a region between the optical fiber and the outer tube comprises a deformable material; elongating the optical fiber and the outer tube together to a desired amount; and relaxing the optical fiber and the outer tube; where the optical fiber retains a larger portion of the elongation than the outer tube.

### BRIEF DESCRIPTION OF THE FIGURES

FIG. 1 depicts an exemplary cable sensor that comprises an optical fiber disposed in a flexible protective tube that serves to protect the fiber from temperature variations, variations in strain, or from other perturbations;

FIG. 2 is an exemplary isometric view of the optical fiber that is located in the cable sensor; and

FIG. 3 is an exemplary schematic depiction of the process equipment used to manufacture the cable sensor.

### DETAILED DESCRIPTION

Disclosed herein is an optical fiber acoustic sensing cable that is sensitive to acoustic signals, while at the same time eliminating any transmission degradation of the acoustic signal caused by temperature fluctuations or strain on the optical fiber acoustic sensing cable. The optical fiber acoustic sensing cable will hereinafter be termed a cable sensor.

In an embodiment, the cable sensor contains an optical fiber that has up to 2% excess fiber length (EFL) compared with the length of a surrounding protective tube that contains the optical fiber. The excess length permits the cable sensor to be stretched without subjecting the optical fiber to any strain that can promote deterioration or degradation of the acoustic signal. The cable sensor may be affixed to a device such as a pipe or a rope that is used for purposes of underground or underwater exploration. This will be discussed in detail later.

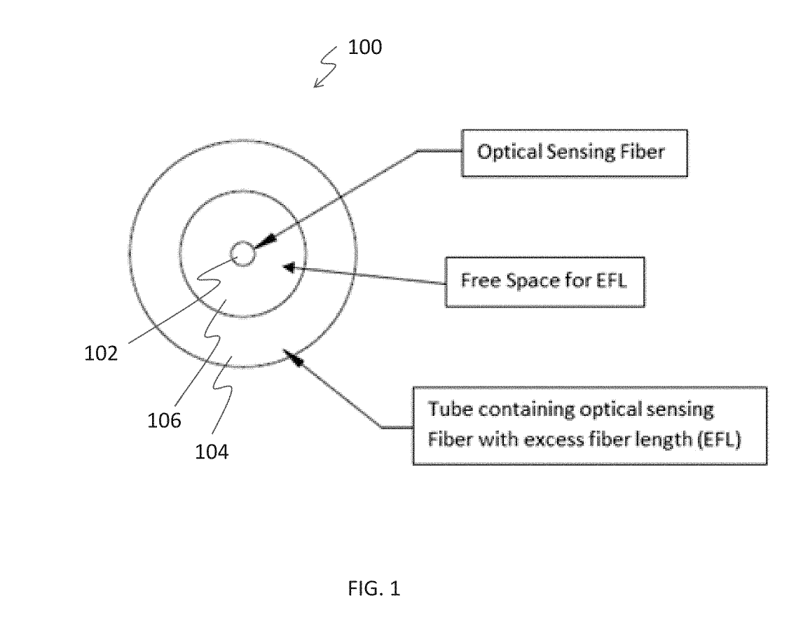

With reference now to FIG. 1, the cable sensor 100 comprises an optical fiber 102 disposed in a flexible protective tube 104 that serves to protect the fiber from temperature variations, variations in strain, or from other perturbations. The flexible tube 104 surrounds the optical fiber 102 and contains a deformable material 106 that permits deformation without deformation of the optical fiber 102 when the cable sensor 100 is subjected to any form of perturbation. The deformable material 106 is disposed between the optical fiber 102 and the flexible tube 104.

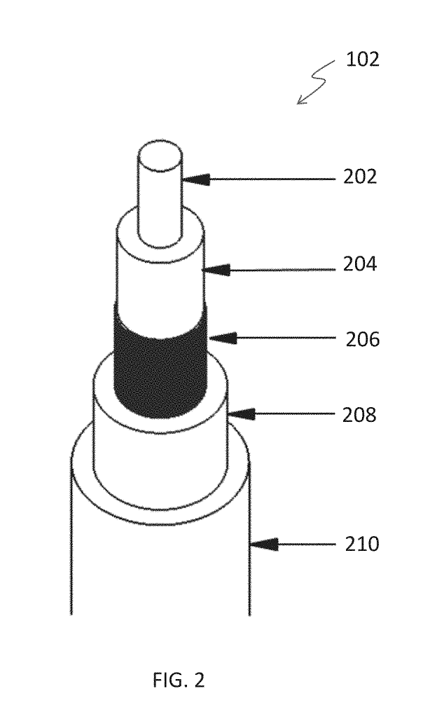

With reference now to FIG. 2, the optical fiber 102 (which serves as a sensor) comprises a core 202, a cladding 204 disposed on the core 202, a carbon layer 206 disposed on the cladding 204, a primary coating 208 disposed on the carbon layer 206 and a secondary coating 210 disposed on the primary coating 208. The optical fiber 102 within the flexible tube 104 may be a single mode or multimode fiber. In an embodiment, the core of the optical fiber 102 is a silica core 202 having an outer diameter of 5 to 100 micrometers, preferably 10 to 50 micrometers, and preferably 15 to 35 micrometers. The core 202 may be doped with germania (GeO₂), phosphorus pentoxide (P₂O₅), alumina (Al₂O₃) or a combination thereof, to raise the refractive index of the core.

The core 202 has a layer of cladding 204 concentrically applied over the fiber core. This cladding 204 has a lower refractive index than the core 202 to confine the distributed acoustic signal traveling back along the optical core. The cladding has an outer diameter in the range of 80 to 250 micrometers.

The cladding 204 is made from silica with no doping, or alternatively, made from silica with a dopant that reduces the refractive index relative to the refractive index of the core. Suitable dopants that are used to reduce the refractive index of the cladding relative to the core include fluorine or boron oxide.

The cladding 204 may optionally be coated with a layer of amorphous carbon 206 to create a hermetic protective layer over the sensing fiber. The layer of amorphous carbon 206 is a hermetic coating that is impervious to molecular water or hydrogen that may be present in the sensing environment. It has been shown that the ingress of hydrogen and water into the silica glass core can cause crack growth from flaws that may already exist within the silica glass. Such crack growth could result in premature failure of the optical fiber sensor.

Coatings 208 (primary coating) and 210 (secondary coating) are applied to the cladding or to the carbon layer during the production of the optical fiber 102 to maintain the pristine condition of the core 202 (e.g., the silica glass sensing fiber which exists within the manufacturing optical fiber drawing process). The coatings also provide for easier handing of the optical fiber sensor. The coatings are preferably selected to meet the lower and upper service temperatures encountered by the optical fiber as well as to protect the core of the fiber from harsh chemical environments that can be encountered in oil wells or in other mining operations.

It is desirable for the coatings to protect the optical fiber from temperatures of −50° C. to +150° C. These coatings are thermosetting and may be cured with temperature (i.e. thermally cured) or with ultraviolet (UV) light. The coating may be applied in two or more layers. The primary coating 208 (also sometimes referred to a first layer) comprises a very soft material. It may be a silicone or urethane based coating. This soft primary layer provides resistance to micro-bending within the optical fiber when strained. Excessive micro-bending can result in signal loss within the optical fiber. The outside diameter of the primary coating may be 120 to 250 micrometers.

A secondary coating 210 is disposed over the primary coating to provide a harder protective shell to the coated optical fiber. The secondary coating has a higher hardness than the primary coating. The harder secondary coating also provides ease of handing of the optical sensing fiber. This harder layer may be a material such as cross-linked acrylate, cured with temperature or ultraviolet light. In some instances an extruded thermoplastic material may be used as the secondary coating for the optical acoustic sensing fiber. Examples of commercially available materials that are used to meet the environmental requirements of the sensing application are polyvinylidene fluoride)(KYNAR®, polytetrafluoroethylene (TEFLON®), polyurethanes, or a combination thereof. The outside diameter of the secondary coating may be 170 to 320 micrometers.

The optical fiber 102 has a length that is 0.1 to 2% longer than the length of the flexible tube 104 that surrounds it. In an alternative embodiment, the optical fiber 102 has a length that is 0.5 to 1.5% longer than the length of the flexible tube 104 that surrounds it. In yet an alternative embodiment, the optical fiber 102 has a length that is 0.7 to 1.4% longer than the length of the flexible tube 104 that surrounds it. This additional length permits the optical fiber to flex, bend, or to stretch, without any undesirable perturbation to the optical or acoustic signals being transmitted along the core of the fiber when the flexible tube 104 is flexed, bent, or stretched in application.

With reference now again to the FIG. 1, the optical fiber 102 (which is used for sensing) is surrounded by a deformable material 106. The deformable material 106 permits the fiber to deform without imposing any stress or strain on the fiber that can cause signal deterioration. The deformable material is therefore a material that is easily compressed or that has a low modulus of elasticity. The deformable material 106 preferably does not interact with the primary or secondary coating.

In an embodiment, the deformable material 106 comprises a fluid such as air, inert gases such as nitrogen, argon, carbon dioxide; water, oil, organic liquids, or a combination thereof. A preferred fluid is air.

In another embodiment, the deformable material 106 can comprises an elastomeric material. Elastomeric materials are those that have an elastic modulus of less than 10⁶ pascals when measured at room temperature. Examples of elastomeric materials are polysiloxanes, polyurethanes, styrene-butadiene rubbers, polybutadiene, polyisoprene, styrene-butadiene-acrylonitrile rubbers, polychloroprene, perfluoro elastomers, fluorosilicone elastomers, fluoro elastomers, ethylene vinyl acetate, polyetherimides, or the like, or a combination thereof.

The elastomers may be used in the form of a non-flowable solid (having a porosity of less than 10 volume percent), a foam (having a porosity of greater than 70 volume percent), a deformable flowable gel (that can flow without the application of any applied force other than gravity), or a combination thereof.

The deformable material 106 permits the optical fiber 102 to bend or to deform. The deformable material 106 undergoes deformation as a result of forces transmitted to it by the outer tube 104 and/or by the fiber 102. In undergoing deformation, the deformable material prevents damage from occurring to the optical fiber 102.

The outer tube 104 encloses the deformable material 106 and the optical fiber 102. It is desirable for the material used to manufacture the outer tube to be highly flexible for use in long term dynamic applications, have a low coefficient of thermal expansion and contraction for dimensional stability over the operating temperature range, be capable of withstanding both a low and high service temperature, have a high tensile modulus for strength, display chemical resistance for use in harsh environments, and display abrasion resistance for toughness and imperviousness to UV degradation for exposure to sunlight.

The outer tube 104 tube has an outer diameter of 1.5 to 2.0 millimeters (mm), preferably 1.6 to 1.9 mm and an inside diameter of 0.8 to 1.2 mm, preferably 0.9 to 1.1 mm. These dimensions, outer and inner diameter, may vary depending on the system installation factors, so long as an appropriate amount of EFL is contained within the tube. This construction also allows for the transmission of acoustic signals through the tube material as well as through the deformable material within the tube to the optical fiber sensor.

The outer tube 104 material preferably comprises a polymeric material having a glass transition temperature of greater than 150° C. In an embodiment, the outer tube comprises a fluoropolymer, a perfluoropolymer, or copolymers thereof. Copolymers of the fluoropolymer are preferred. Suitable commercially available fluoropolymers for use in the outer tube are KYNAR for polyvinylidene fluoride; TEFZEL for ethylene tetrafluoroethylene; TEFLON, FLUON, DYNEON and NEOFLON.

In an embodiment, the cable sensor 100 is used in conjunction with other devices that are introduced downhole to make measurements or to retrieve samples or even tools. The cable sensor 100 may therefore be used in conjunction with drilling equipment, cables and ropes, and other equipment that is introduced into subterranean formations. An acoustic fiber sensor is typically embedded or integrated as a component in a larger object which is subject to temperature and strain. Often this object/structure is used to measure temperature and strain. An acoustic sensing fiber contained within its own unique and robust cable structure is required to assure the acoustic sensor remains in a strain-free environment after the integration or installation processes of the larger object or structure.

In an embodiment, the cable sensor 100 is designed to withstand the force experienced during integration into CapWell's Capline Downhole Rope, 30-40N, which is used to lower and retrieve various downhole tools at their target depth inside wells. The rope is made of high-strength synthetic fibers and is highly resistant against mechanical cuts and abrasion. It is fitted with an optical fiber that can be used either as a sensor by itself or used for signal transmission. The rope has been extensively tested to verify its compatibility with well chemicals and temperatures and is therefore well qualified for downhole services.

The cable sensor 100 for use in this application comprises a tube containing the optical sensing fiber having sufficient excess length to allow for up to 2% elongation of the cable without putting any mechanical stress on the optical fiber acoustic sensor inside the tube. Temperature effects have also been isolated from the acoustic sensing characteristics of this cable.

In another embodiment, the cable sensor 100 is run down alongside an oil pipe which is retrieving the oil from a deep oil well. Different types of oil, natural gas, water, all emit a unique acoustic signal. Leaks can also be detected. An optical pulse is transmitted down the sensing fiber. The acoustic signal causes a backscattering of the optical pulse which is called Rayleigh scattering. Rayleigh-based sensing allows for distributed acoustic monitoring over very long lengths. The cable sensor may be used to transmit and receive signals for up to 50 kilometers.

For oil exploration, a blast is detonated in the ground or ocean floor some distance away from the DAS system. The signature of the DAS transmitted along the sensor fiber can help detect the location, depth and type of oil well beneath the ground. In these DAS (distributed acoustic sensing fibers) an optical signal is transmitted down the fiber at the top of the oil well. The acoustic signal is used for oil exploration and oil recovery.

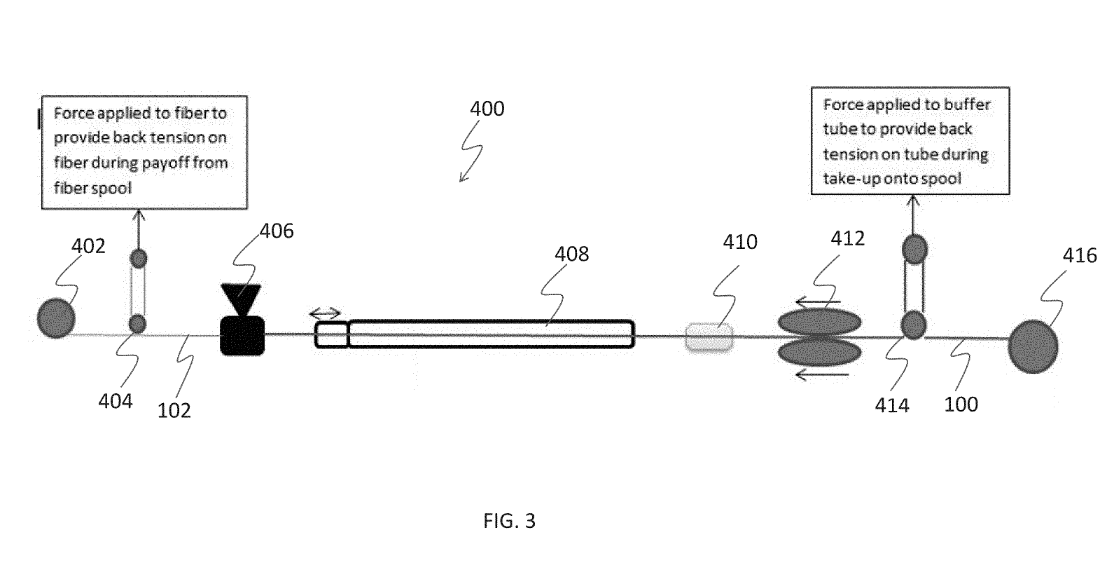

In one embodiment, a method of manufacturing the cable sensor 100 is depicted in the FIG. 3. FIG. 3 depicts one embodiment of an exemplary device 400 that comprises the following pieces of equipment that are used to manufacture the cable sensor 100.

402: Spool of optical fiber 102 that is being payed-off (fed) to the extrusion line.

404: Pay-off control where uniform back tension is applied to the optical fiber 102 during the buffering process. Buffering is the process of extruding the outer tube 104 onto the optical fiber 102.

406: Extruder where plastic material is melted and applied onto the optical fiber 102 as it passes through the extruder crosshead. Crosshead extrusion is used to dispose the outer tube 104 on the optical fiber 102 to produce the cable sensor 100. In the extrusion step, the deformable material 106 may also be extruded onto the optical fiber 102. More than one extruder may be used if multiple layers of material are disposed on the optical fiber 102.

408: Water cooling trough where the hot plastic melt from the extruder crosshead is cooled. Water temperature is controlled. The water can be hot, cool, or cold. There may be several independently controlled sections within the cooling trough to provide a gradual cooling process to the buffer (e.g. hot to cool to cold). The trough may have a movable section indicated by the left/right arrow. The movable section facilitates the development and control of the air gap between the extruder crosshead and the water trough. The air gap might be less than an inch up to several feet long depending on how the process is set-up.

410: is a measurement device that facilitates diameter measurement and control to record and control the dimension of the buffer. The extruded product may be round or some other shape. The shape of the finished product is determined by the crosshead tooling.

412: denotes a capstan. The capstan pulls the product as its being extruded/formed. The arrows show the direction of the counter rotating capstan tractor type belts which capture the buffered fiber and pull it from pay-off to take-up. The faster the capstan rotates, the faster the line speed of the buffering line.

414: denotes an accumulator and take-up tension control device that provides constant and uniform tension to the buffered fiber as it is being taken up onto the take-up spool. The accumulator allows the take-up spool to be stopped and changed from a full spool to a new empty spool without stopping the extrusion line.

416: denotes a take up spool for collecting the cable sensor 100.

It is to be noted that not all pieces of equipment depicted in the FIG. 3 are necessary. Some of them are optional.

In one embodiment, an optical fiber 102 is mounted on a spool 402 and fed to a cross head extruder 406 via a pay-off control 404. As noted above, if more than one layer is to be disposed on the optical fiber 102, then more than one extruder may be used in the crosshead configuration. The extruder 406 disposes the outer tube 104 (comprising the polymer) on the optical fiber 102.

Engineering polymers (plastics) tend to shrink upon cooling. They shrink radially, which is why the diameter of the outer tube is monitored and controlled as close to the take-up spool as possible. The polymers in the outer tube also shrink longitudinally. In the case of loose tube buffer extrusion, when the tube shrinks longitudinally as it cools, prior to the take-up spool 416, the tube becomes shorter than the optical fiber inside the loose tube. This can cause the optical fiber 102 to be stressed and may even result in kinking of the optical fiber inside the tube. This stress can result in optical loss, or attenuation, in the buffered optical fiber. The extrusion temperatures and pressures are selected to minimize shrinkage of the buffer outer tube during cooling, prior to take-up. However, there is always some shrinkage upon cooling. To remove the excess fiber (which may cause high optical loss in the finished product) that has been created by the tube shrinkage upon cooling, back tension on the optical fiber during pay-off 404 is applied before it passed through the extruder crosshead 406.

In order to create a product with a defined amount of excess fiber within the loose tube (EFL), the production line is set-up to produce the product as one would normally where the optical fiber and the loose tube are the same length, i.e. no excess fiber. To facilitate the EFL, the take-up tension at the accumulator 414 is increased to elongate the tube within the accumulator. The lower sheaves of the accumulator 414 are in a fixed vertical position. The upper sheaves are allowed to move up or down. By applying an upward force on the upper sheave of the accumulator, the buffer tube is stretched between the lower and upper sheave of the accumulator 414. Additional optical fiber is then is pulled into the tube to accommodate the new stretched length of buffer tube. Back tension on the optical fiber at payoff 404 must not be too high.

The product on the take-up spool 416 is now wound onto the spool very tightly. It is “stretched” on to the spool. If for example 2% excess fiber length (EFL) is desired, the tube would have to be stretched to at least 2%.

In a secondary operation, the spool is re-spooled. During the re-spooling operation all back tension on the loose tube optical fiber is removed thereby allowing the buffered tube to return to an un-stretched condition before being wound onto a take-up roll under normal tension. Normal tension is not so high that the tube is stretched but high enough to stay on the spool without shifting during handing or shipping. It is when the buffer tube is un-stretched that the excess fiber is created, as long as the tube has not stretched beyond its yield point, i.e. the tube is still fully elastic. Also, the inside diameter of the tube is large enough to allow enough free space to take-up the excess fiber without stressing the optical fiber within the tube which would cause high attenuation (optical loss).

In other words, during the extrusion process, both the optical fiber 102 and the outer tube 104 are simultaneously stretched to the desired EFL using the payoff 404 and the capstan 414. When both the optical fiber 102 and the outer tube 104 are relaxed, the outer tube 104 relaxes because of its lower modulus of elasticity than the modulus of elasticity of the optical fiber 102. In this manner, excess fiber is created within the tube.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A cable sensor comprising:
an optical fiber; where the optical fiber comprises an optical core upon which is disposed a cladding; and a primary coating;
a deformable material surrounding the optical fiber; and
an outer tube surrounding the deformable material; where the optical fiber is longer than the outer tube by an amount of 0.1 to 2%.

2. The cable sensor of claim 1, where the deformable material comprises a fluid.

3. The cable sensor of claim 2, where the fluid is air.

4. The cable sensor of claim 1, where the deformable material comprises an elastomer having an elastic modulus of less than 10⁶ Pascals measured at room temperature.

5. The cable sensor of claim 1, where the elastomer is in the form of a foam, a non-flowable solid or a flowable gel.

6. The cable sensor of claim 1, where the optical fiber is longer than the outer tube by an amount of 0.5 to 1.5%.

7. The cable sensor of claim 1, where the outer tube has an outer diameter of 1.5 to 2 millimeters.

8. The cable sensor of claim 1, where the outer tube has an inner diameter of 0.8 to 1.2 millimeters.

9. The cable sensor of claim 1, where the outer tube comprises a fluoropolymer.

10. The cable sensor of claim 1, where the outer tube comprises a copolymer of a fluoropolymer.

11. The cable sensor of claim 1, having a length that exceeds 50 kilometers.

12. An article comprising the cable sensor of claim 1.

13. The article of claim 12, where the cable sensor is affixed to a tube or a rope.

14. A method of manufacturing the cable sensor of claim 1, comprising:
mounting an optical fiber on a spool; where the optical fiber comprises a core; a cladding and a primary coating;
charging the optical fiber from the spool to an extruder;
extruding an outer tube onto the optical fiber such that a region between the optical fiber and the outer tube comprises a deformable material;
elongating the optical fiber and the outer tube together to a desired amount; and
relaxing the optical fiber and the outer tube; where the optical fiber retains a larger portion of the elongation than the outer tube.
